(19) United States
(12) Patent Application Publication
(10) Pub. No.: US 2004/0000774 A1
(43) Pub. Date: Jan. 1, 2004

(54) Collapsible display cart

(76) Inventor: David Zeuner, Sewell, NJ (US)

Correspondence Address: BLANK ROME LLP, 600 NEW HAMPSHIRE AVENUE, N.W., WASHINGTON, DC, 20037, US

(21) Appl. No.: 10/184,047

(22) Filed: Jun. 28, 2002

(51) Int. Cl. B62B 1/00

(52) U.S. Cl. 280/651

(57) ABSTRACT

A display cart has three sections: a base, an intermediate display section and an upper section having a canopy. The cart can be placed in a storage position, wherein the intermediate display section and upper section are lowered. In the storage position, the intermediate display section is substantially contained within the base and the canopy of the upper section surrounds the top portion of the base. The intermediate display section and the product are thereby concealed within the base, and protected by the canopy of the upper section. The cart can be locked in the storage position to secure the product when the cart attendant is absent. The cart can also be placed in an operating position, wherein the intermediate display section and the upper section are fully extended. The intermediate display section includes shelves that slide outward to display the product in a tapered manner so that all the products can be easily viewed without interference from other product. The upper section raises the canopy high to be viewed from greater distances to attract customers.

### BACKGROUND OF THE INVENTION

1. Field of the Invention

The present invention relates to a cart for displaying product. More particularly, the present invention relates to a collapsible display cart having a shelving unit for displaying glasses.

2. Background of the Related Art

Carts have been developed having sections that can be raised and lowered, such as shown in U.S. Pat. No. 5,129,611 to Grover et al. and U.S. Pat. No. 2,575,725 to McKay. Those carts, however, are rather simplistic in design. Consequently, prior carts do not provide any mechanism for locking the cart and securing the items displayed on the cart. In addition, conventional carts are not designed to display multiple products being offered for sale.

Accordingly, there is a need for a cart that can be used in a commercial sales environment or other locations having heavy foot traffic, such as a shopping mall, street, beach, or park. The cart must be able to display multiple products in a manner which is easily viewable by passersby, and also secure the product when the cart attendant is absent. The cart must also be capable of being easily moved as the product is displayed, and sufficient compact to be moved to various vending locations.

### SUMMARY OF THE INVENTION

Accordingly, it is an object of the invention to provide a cart for displaying multiple products to passersby. It is another object of the invention to provide a display cart having shelves that display multiple products without interfering with viewing of each other. It is still another object of the invention to provide a display cart which secures the product when the cart attendant is absent. It is yet another object of the invention of providing a display cart that is collapsible while retaining the product, so that the cart and product can be easily and conveniently moved great distances.

In accordance with these and other objectives, the present invention is a display cart having three sections: a base, an intermediate display section and an upper section having an awning or canopy. The cart can be placed in a storage position, wherein the intermediate display section and upper section are lowered. In the storage position, the intermediate display section is substantially contained within the base, and the canopy of the upper section surrounds the top portion of the base. The intermediate display section and the product are thereby concealed within the base, and protected by the canopy of the upper section. The cart can be locked in the storage position to secure the product when the cart attendant is absent.

The cart can also be placed in an operating position, wherein the intermediate display section and the upper section are fully extended. The intermediate display section includes shelves that slide outward to display the product in a tapered manner so that all the products can be easily viewed without interference from other product. The upper section is raised high so that the canopy can be viewed from greater distances to attract customers.

### BRIEF DESCRIPTION OF THE FIGURES

FIG. 1 is a perspective view of the display cart in the operating position in accordance with the preferred embodiment of the invention.

FIG. 2 is a perspective view of the display cart in the storage position.

FIG. 3 is a view of the bottom of the cart showing the crank system.

FIGS. 4-6 are cutaway front views of the cart showing the telescoping arrangement of the base, intermediate and upper sections of the cart with the cart in a storage position (FIG. 4), operating position (FIG. 6) and a position between the storage and operating positions (FIG. 5).

FIG. 7 is a cutaway side view showing the telescoping arrangement of the base, intermediate and upper sections of the cart.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

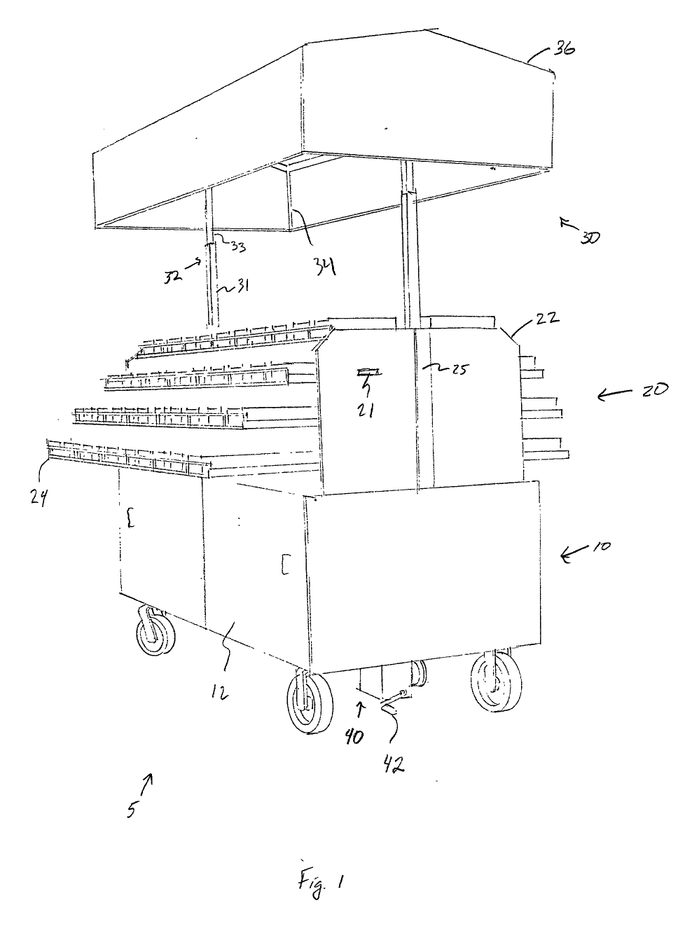

Turning to the drawings, FIG. 1 shows the display cart 5 of the present invention. The cart 5 has three primary components: a housing or base member or section 10, an intermediate display member or intermediate section 20 and an upper member or upper section 30. The display cart 5 has wheels attached to the trunk 10, so that the cart 5 can be easily moved and loaded into a vehicle, such as a cargo van or the like.

The base 10 is slidably engaged with the intermediate display section 20, so that the intermediate display section 20 telescopes in a vertical direction with respect to the base 10. Similarly, the intermediate display section 20 is slidably engaged with the upper section 30, so that the upper section 30 telescopes in a vertical direction with respect to the intermediate display section 20 and the base section 10.

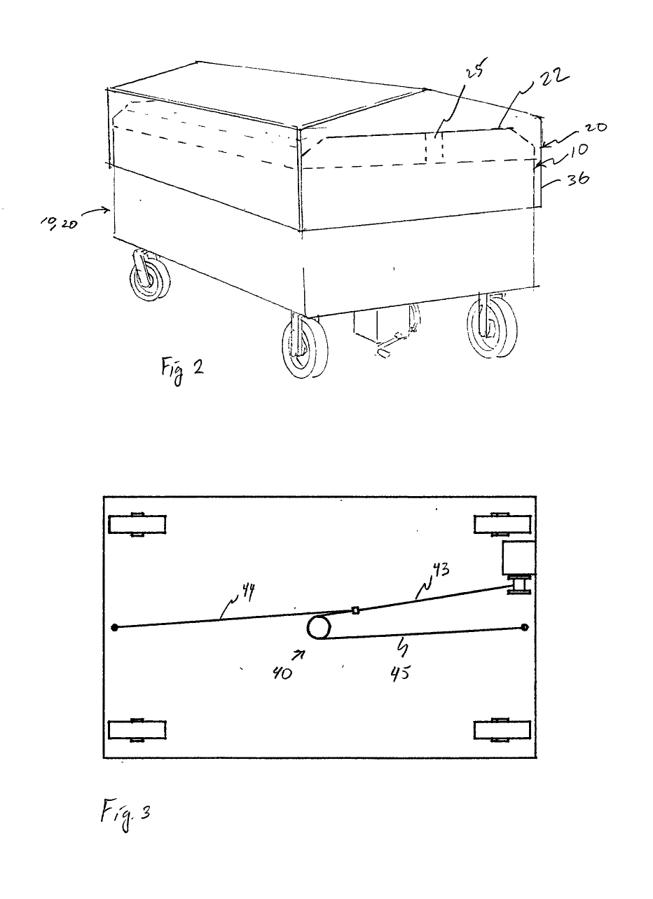

The cart 5 has two positions: an operating position (FIG. 1) and a storage position (FIG. 2). In the operating position, the intermediate display section 20 and the upper section 30 are fully extended upward in the vertical direction. In the operating position, the shelves 24 of the intermediate display section 20 can be extended, and product placed on the shelves 24 for display to passersby. The upper section 30 protects the product and attendant from the sun and rain. In addition, the raised position of the upper section 30 draws attention to the cart 5, and enables any advertisements located on the canopy 36 of the upper section 30 to be visible from a greater distance. The cart 5 preferably has a height of about eight feet in the operating position.

In the storage position (FIG. 2), the intermediate display section 20 and the upper section 30 are fully withdrawn. The intermediate display section 20 is substantially located within an interior chamber or cavity of the base 10. The upper section 30 is lowered to encase the top portion of the combined base 10 and intermediate display section 20. A stop member 21 (FIG. 1) is provided on at least one of the side walls 22 which comes into contact with the upper edge of the base section 10 to prevent the intermediate section 20 from being lowered too far into the base section 10. However, it should be appreciated that the intermediate section 20 need not protrude from the top of the base section 10, but instead can be fully enclosed within the base section 10. In the storage position, the cart 5 is compact for easy movement and storage.

In the storage position, the cart 5 is especially designed to fit within a standard size cargo van for movement between various locations. Accordingly, when the cart 5 is in the storage position, it preferably has a width of about 34 inches, a length of about 75 inches, and a height of about 3 feet. The base 10 has a height of about 22 inches, and the intermediate section has a height of about 20 inches. The cart 5 maximizes display space by minimizing the space required for the side walls 22 of the intermediate section 20. Thus, the shelves 24 extend substantially the entire length of the cart 5, approximately 72 inches long.

The trunk 10 is a rectangular, hollow metal container having side walls 14. Sliding doors 12 are located on the front of the trunk 10 which allow the user to gain access to the interior cavity of the base 10. When the cart 5 is in the operating position, the cart attendant can store additional product or sales material in the base 10. The doors 12 have a lock so that the doors 12 can be locked in the storage and operating positions.

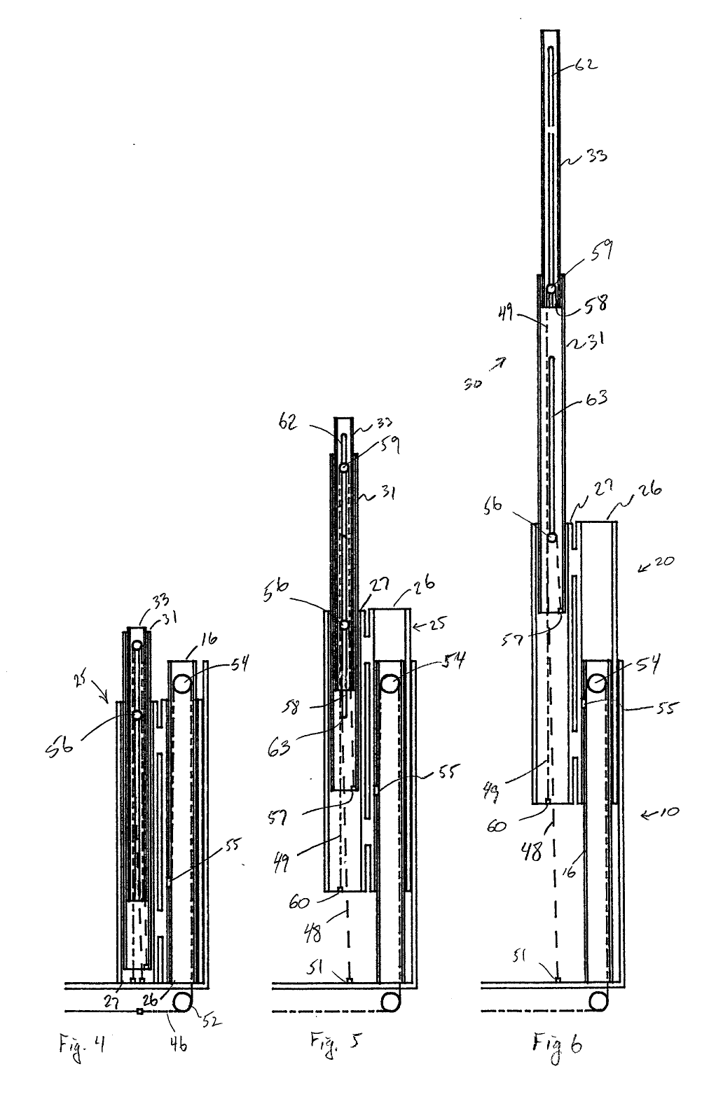

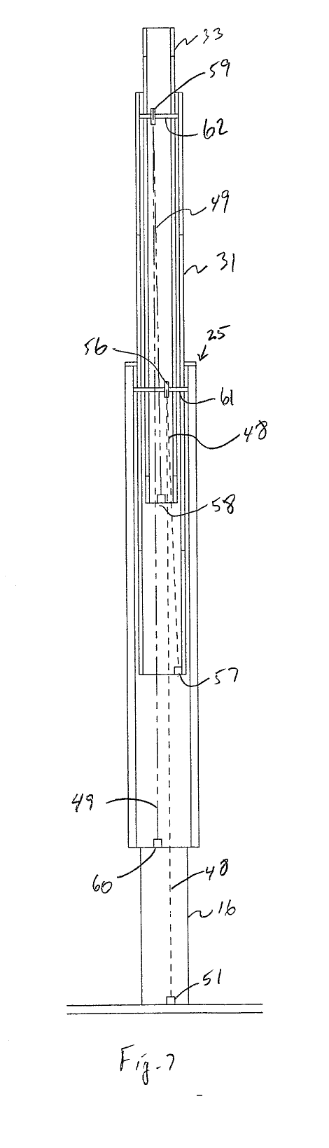

As best shown in FIGS. 4-6, a rectangular elongated support post 16 is attached along the side wall 14 of the trunk 10. The support posts 16 form a channel which extends vertically to receive and slidably engage a respective external post 26 of the intermediate display section 20. The support posts 16 are hollow, to receive a first chain 46 used to raise and lower the intermediate display section 20.

Turning back to FIG. 1, the intermediate display section 20 is defined by two side walls 22 and shelves 24 which extend between the two side walls 22. One or more of the shelves 24 are slidably engaged with the side walls 22 in a horizontal direction. Thus, the shelves 24 can slide outwardly beyond the width of the base 10 when the cart 5 is in the operating position. Conversely, the shelves 24 also slide inwardly to be narrower than the width of the base 10 to position the cart 5 in the storage position.

When the shelves 24 are fully extended, they form tapered tiered layers, such that each shelf 24 is slightly above and behind the shelf 24 just below it. If shelves 24 are provided which extend outwardly at both the front and back of the cart 5, as shown in the embodiment of FIG. 1, the shelves 24 form a general pyramid shape. The shelves 24 are tapered to permit product to be placed on each shelf 24 without being obstructed from viewing by the shelves 24 above it.

The shelves 24 are slidably connected to the side walls 22 in any conventional manner. In the preferred embodiment shown, the shelves 24 have a bottom and upright sides. Sliding tracks with rollers are secured to the outside of the shelf sides and the inside of the side walls 22.

In the preferred embodiment shown in FIG. 1, there are eight (8) shelves 24, four of which are located at the front half of the cart 5, and four which are located at the back half of the cart 5. However, shelves 24 need not be provided on the front and back of the cart 5. Instead, shelves 24 can be provided which extend from the back to the front of the cart 5, but only pull outward at the front of the cart 5. In addition, any suitable number, size and shape of the shelves 24 can be provided without departing from the spirit and scope of the invention. The shelves are about 12½ inches wide. The top shelf 24 is fixed, and the second and third highest shelves slide out about 12 inches, with the lower of the two shelves positioned about 2 inches forward of the higher of the two shelves. The lowest shelf 24 slides out about 14 inches.

Preferably, the products are displayed on display cases that are retained on the shelves 24. An example of a display case is shown in co-pending application Ser. No. ______, which is incorporated herein by reference. The shelves 24 have a front bar which prevents the cases from inadvertently being pulled or otherwise falling off of the shelf 24, while allowing the case to be removed by an attendant to open the case and retrieve product stored in the case.

Returning to FIGS. 4-6, H-shaped frame members 25 are provided at the center of each of the side walls 22 of the intermediate display section 20. The H-frame 25 is formed by an external post 26 and an internal post 27. The external post 26 forms a vertically extending guide, and engages the respective post member 16 of the base 10. The intermediate external posts 26 are hollow to receive a second and third chain 48, 49 used to raise and lower the upper section 30 with respect to the intermediate display section 20.

The top corners of the side walls 22 are beveled so that the side walls 22 do not obstruct viewing of product located on the top shelves 24. The side walls 22 are also beveled to reduce risk of injury, and to increase the attractiveness of the cart 5.

The upper section 30 has two downwardly extending telescoping members 32. Each telescoping member 32 is received in the internal post 27 of the intermediate display section 20. The telescoping member 32 is formed of two telescoping leg sections 31, 33 to further compact the height of the cart 5 in the stored position and achieve a maximum height of the cart 5 in the operating position. The telescoping member 32 is part of a canopy frame 34 that secures an awning or canopy 36 at the upper section 30 of the cart 5. Advertisements or sales information can be displayed on the canopy 36 to attract customers. The canopy 36 also provides protection to the product and cart attendant against inclement weather, such as rain, sun and snow.

When the cart 5 is in the storage position, the canopy 36 extends down to encase at least the top portion of the intermediate display section 20 and base 10. The canopy frame 34 and the canopy 36 are slightly larger than the base 10 to fit over the base 10 in the storage position. The canopy 36 is a strong material, such as a tarpaulin or rugged plastic, which prevents rain and snow from entering the encased cart 5 in the operating and storage positions. In addition, the canopy 34 secures the product against theft while the cart 5 is in the storage position.

Turning to FIG. 3, a crank system 40 is provided to raise and lower the cart 5 between the operating and storage positions. The crank system 40 includes a gear box, cables 43-45, chains 46, 48, 49 and gears which simultaneously raise and lower the intermediate display section 20 and the upper section 30. Accordingly, the intermediate display section 20 and upper section 30 both reach the storage position and the operating position at the same time, and it is not necessary to individually raise and lower each of the sections 20, 30.

A handle 42 is provided at the exterior of the base 10 to enable the cart attendant to manually raise and lower the intermediate and upper sections 20, 30 of the cart 5. Once the cart 5 is in the appropriate operating or storage position, the handle 42 can be removed, thereby locking the cart 5 in that position. The handle 42 can be stored in the internal cavity of the base 10, or retained by the attendant. However, the handle 42 can be replaced by a motor which raises and lowers the intermediate and upper sections 20, 30.

The gear box is connected to a first cable 43, which in turn is connected to a second and third cable 44, 45. The second cable 44 extends to the far end of the cart 10, where it connects to the first chain 46. The third cable 45 is wrapped around a horizontally mounted pulley, and extends back to the near end of the cart 5 at which the gear box is mounted, and connects to another first chain 46. The cables 43, 44, 45 maintain tension on the crank system 40 as the cart 5 is raised and lowered. The cables 43-45 also absorb energy, to prevent the gearbox from exerting too much force on the chains.

As best shown in FIGS. 4-7, the first chain 46 is positioned about a first pulley 52 located underneath each end of the cart 5 just beneath the support post 16 of the base 10. The first pulley 52 directs the first chain 46 up through the hollow support post 16. The support post 16 protects against passersby coming into contact with the chain 46. The first chain 46 extends around a second pulley 54, back down through an opening in the support post 16, and is secured by a weld 55 or the like to the inside of the external post 26 of the H-frame 25 at the intermediate section 20. The second pulley 54 is attached at the top of the support post 16 by a pin (not shown) affixed to the sides of the support post 16.

A second chain 48 is connected to the floor of the base 10 at weld 51, and extends up through the hollow internal post 27 of the H-frame 25 of the intermediate section 20. The second chain 48 wraps around a third pulley 56 and extends back down and attaches to the inside of the lower leg 31 of the telescoping member 32 by a weld 57 or the like. The third pulley 56 is attached to the internal post 27 of the H-frame 25 by a pin 61. The pin 61 is attached to the sides of the internal post 27 and extends through openings 62, 63 in the lower and upper telescoping legs 31, 33.

A third chain 49 attaches to the inside of the upper leg 33 of the telescoping member 32 at a weld 58. The third chain 49 extends around a pulley 59 which is attached to the lower leg 31 of the telescoping member 32 by a pin 62 that extends through an opening 62 in the upper leg 33. The opposite end of the third chain 49 is attached to the bottom of the internal post 27 of the H-frame 25 at a weld 60.

Respective slots 62, 63 are located in the upper leg 33 and lower leg 31 which enable the legs 33, 31 to move with respect to the pins retaining the pulleys. The slot 62 of the upper leg 33 extends completely through the bottom of the upper leg 33 so that the upper leg 33 can be raised past the pin of the pulley 56. Thus, the upper leg 33 has the slot 62 cut in its sides to form an inverted U-shape. The upper leg 33 remains sturdy since it is positioned within the lower leg 31 and since the top of the upper leg 33 connects the U-shape.

Accordingly, as the gear box is operated to raise the cart 5 to the operating position, the first cable 43 pulls the second pulley 44, which pulls the first chain 46. Since the first chain 46 is attached to the external post 26 of the intermediate section 20, the first chain 46 raises the intermediate section 20. As the intermediate section 20 raises, it causes the second chain 48 (which is attached to the floor of the base 10) to raise the lower leg 31 of the telescoping member 32. Since the third chain 49 is fixed to the bottom of the internal post 27 of the intermediate section 20, the raising of the lower leg 31 causes the third chain 49 to raise the upper leg 33 of the telescoping member 32.

When lowering the cart 5 to the storage position, the crank system 40 operates in a reverse manner. The weight of the cart 5 assists in the cart 5 being lowered. A spring can also be provided to further assist in lowering the cart 5. The sprint attaches to the bottom of the base 10 and the side walls 22 of the intermediate section 20 to maintain the tension on the cables and chain as the cart 5 is being lowered. Likewise, springs can be connected to the telescoping member 32 to maintain tension on the third chain 49 as the cart 5 is being lowered.

In operation, the cart 5 is initially in the storage position and delivered to a general location by van. The cart 5 is rolled out of the van to approximately the desired location. The wheels are then locked to prevent inadvertent movement due to bumping or pushing of the cart 5. The handle 42 is inserted into a gearbox of the crank system 40, and turned to simultaneously raise the intermediate and upper sections 20, 30 to the operating position.

Once the cart 5 is in the operating position, the handle 42 can be removed to lock the cart 5 in that position. To return the cart 5 to the storage position, the handle 42 is inserted into the crank system 40, and turned to simultaneously lower the intermediate and upper sections 20, 30 to the storage position. Once the cart 5 is in the storage position, the handle 42 can be removed to lock the cart 5 in that position. The wheels can then be unlocked and the cart 5 moved and loaded to the van.

The cart 5 is preferably constructed of a strong, yet lightweight metal, so that the cart 5 is easy to move, yet durable. In addition, although the cart 5 has only been described as being moved when it is in the storage position, the cart 5 can also be moved in the operating position. Thus, the vendor can move the cart 5 while in the operating position, so that the vendor can cover a greater area such as a beach strip, mall or the like. In addition, though the cart 5 is preferably rectangular, other suitable shapes may be used, such as a circle or oval.

The foregoing description and drawings should be considered as illustrative only of the principles of the invention. The invention may be configured is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

I claim:

1. A display cart for displaying product, comprising a base defining an interior cavity, and an intermediate display member having a plurality of shelves for displaying the product including a lower shelf and an upper shelf, said intermediate display member movably engaged to said base to lower said intermediate display member to within the interior cavity of said base and raise said intermediate display member to extend outside said base, wherein the lower shelf is slidably engaged to said intermediate display member so that the upper shelf does not obstruct product on the lower shelf.

2. The display cart of claim 1, wherein said intermediate display member includes side walls, the plurality of shelves extend between the side walls, and the lower shelf is slidably connected to the side walls.

3. The display cart of claim 1, further comprising an upper member having a canopy, said upper member movably engaged to said intermediate display member to lower said upper member to encase at least a portion of said intermediate display member and raise said upper member to extend above said intermediate display member.

4. The display cart of claim 3, further comprising a lifting device for raising and lowering said intermediate display member and said upper member.

5. The display cart of claim 3, wherein said upper member encases at least a portion of said base.

6. A display cart for displaying product, comprising:
a base defining an interior cavity;
an intermediate display member having at least one shelf for displaying the product, said intermediate display member telescopically engaged to said base to lower said intermediate display member to within the interior cavity of said base and raise said intermediate display member to extend outside said base; and,
an upper section having a canopy, said upper section telescopically engaged to said intermediate display member to lower said upper section to encase at least a portion of said intermediate display member and raise said upper section to extend above said intermediate display member.

7. The display cart of claim 6, wherein said intermediate display member includes side walls, and the at least one shelf extends between the side walls.

8. The display cart of claim 6, further comprising a lifting device for raising and lowering said intermediate display member and said upper member.

9. The display cart of claim 6, wherein said upper member encases at least a portion of said base.

10. A collapsible display cart having an operating position for displaying product and a storage position for securing the product, the collapsible cart comprising:
a base defining an interior cavity;
an intermediate display member having side walls and at least one shelf for displaying the product, the side walls movably engaged to said base to lower said intermediate display member to within the interior cavity of said base in the storage position and raise said intermediate display member to extend outside said base in the operating position; and,
an upper section having a canopy, said upper section movably engaged to said intermediate display member to lower said upper section to encase at least a portion of said intermediate display member in the storage position and raise said upper section to extend above said intermediate display member in the operating position.

11. The display cart of claim 10, further comprising a lifting device for raising and lowering said intermediate display member and said upper member.

12. The display cart of claim 11, wherein said lifting device includes a lock for locking the cart in the storage position.

13. The display cart of claim 10, wherein said upper section encases at least a portion of said base in the storage position.

14. The display cart of claim 10, said upper section having legs, wherein said upper section is movably engaged to said intermediate display member by movably engaging the legs of said upper section with the side walls of said intermediate display member.

15. The display cart of claim 10, wherein said base has a rectangular shape.

16. The display cart of claim 10, wherein the at least one shelf comprises a lower shelf and an upper shelf, and wherein the lower shelf is slidably connected to the side walls of said intermediate display member so that the upper shelf does not obstruct product on the lower shelf.
